(19) United States
(12) Patent Application Publication
(10) Pub. No.: US 2007/0235278 A1
(43) Pub. Date: Oct. 11, 2007

(54) Clutch

(76) Inventor: Eckhardt Lubke, Friedrichshafen (DE)

Correspondence Address: DAVIS & BUJOLD, P.L.L.C., 112 PLEASANT STREET, CONCORD, NH, 03301, US

(21) Appl. No.: 11/578,857

(22) PCT Filed: Apr. 9, 2005
(86) PCT No.: PCT/EP05/03747

§ 371 Date: Oct. 19, 2006

(30) Foreign Application Priority Data
Apr. 21, 2004 (DE) 10 2004 019 280.4

(51) Int. Cl. F16D 11/00

(52) U.S. Cl. 192/53.2

(57) ABSTRACT

A clutch (1), in particular a friction clutch, with a diaphragm spring exerting stress on a pressure plate of the clutch and connected to a disengaging device (4, 9) that acts on its radial inner area and can be activated by way of an electromechanical actuator (5) and is intended to cancel the stress exerted by the diaphragm spring on the pressure plate when the clutch is engaged. The clutch (1) can be achieved by serially integrating a pressure spring (10) into the mechanical transmission path between the electromechanical actuator that activates the disengaging device and the disengaging device itself so that, when the clutch is in an engaged state, a defined basic force is exerted on the disengaging device while vibration decoupling of the electromechanical actuator is realized.

This application is a national stage completion of PCT/EP2005/003747 filed Apr. 9, 2005, which claims priority from German Application Serial No. 10 2004 019 280.4 filed Apr. 21, 2004.

### FIELD OF THE INVENTION

The invention relates to a clutch, in particular a friction clutch, which is placed in the power train of a motor vehicle between a combustion engine and a transmission, with a diaphragm spring exerting stress on a pressure plate of the clutch. The diaphragm spring, in turn, is connected to a disengaging device acting on the radial inner area of the diaphragm spring. The disengaging device can in turn be activated by an electromechanical actuator.

### BACKGROUND OF THE INVENTION

Clutches and clutch actuation devices of this type have been known for a fairly long time in a plethora of embodiments. Their electromechanical actuators feature a pressure spring, which is normally situated parallel to the mechanical transmission path and comes to bear on both the disengaging device and a fixed part of the housing. When the clutch is engaged, a defined preset basic force should be exerted on the disengaging device, also designated a release bearing, by way of this pressure spring in order to extend the service life of the disengaging device.

Against this background, the object of the invention is to produce a clutch of the type described above, which is improved in terms of the electromechanical actuator and the connection thereof to a disengaging device.

### SUMMARY OF THE INVENTION

The invention is based on the notion that a defined preset basic force can be exerted on the disengaging device by way of a pressure spring of the prior art. However, it has been impossible to prevent the vibrations produced or transmitted by the parts of the clutch attached to the disengaging device from being conducted to the electromagnetic actuator and negatively influencing or even damaging this component.

Accordingly, the stated objective in connection with the features in the preamble of claim 1 is achieved through serial integration of a pressure spring into the mechanical transmission path between the disengaging device and the electromechanical actuator that activates the disengaging device, so that when the clutch is engaged, a defined basic force is exerted on the disengaging device, and at the same time, vibration is decoupled from the electromagnetic actuator.

By using a single pressure spring, the exertion of a basic force on the disengaging means is advantageously combined with decoupling of vibration from the actuator. The pressure spring requires only short spring travel to achieve its effect, resulting in a more cost-effective, smaller and thus lighter pressure spring, as well as a smaller installation space for this part.

In one especially advantageous embodiment of the invention, the disengaging device takes the form of a piston routed into a guide bushing fixed to the electromechanical actuator. One end of the piston is connected to the diaphragm spring, while the other end is functionally connected to a displacing device of the electromechanical actuator acting axially on the piston—spring-elastically via the pressure spring when the clutch is engaged and directly when the clutch is disengaged.

In this example, the disengaging device and the electromechanical actuator thereby constitute a structural unit, which has positive effects, particularly with regard to assembly cost.

In an improvement of the invention, the electromechanical actuator features an electric motor, which is connected via a gear to the displacing device acting axially on the pressure spring and/or the piston. In terms of drive technology, the gear can be designed as a threaded spindle drive connected to a displacing device in the form of a displacement spindle. Furthermore, the disengaging device can be connected, via a lever system, to a separate release bearing that acts on the radial inner area of the diaphragm spring. On the other hand, it can also be designed so that the disengaging device itself constitutes the release bearing.

In the scope of the invention, it is further proposed that the basic force exerted by the pressure spring on the disengaging device of the invention can be realized via a defined coupling effect of the electric motor of the electromechanical actuator, and that this is an effect that can be continuously adjusted within defined limits. The coupling effect of the electric motor results in the advantage that the actuator continuously calculates its zero-position, which makes it possible to monitor mechanical wear on the clutch, or the friction lining of the clutch disk, as well as the displacement of disengagement mechanics.

In view of potential mechanical wear on the clutch and the accompanying displacement of disengagement mechanics, the electromechanical actuator could also be equipped with a self-calibrating displacement sensor that determines zero-position at any given time, the actuator then providing the correct signals to a control and regulation device for the electric motor. The displacement sensor can be designed for an incremental or an absolute adjustment of the actuator's zero-position.

In order to maintain the generated coupling effect at times when the clutch is engaged, the electric motor can feature a brake with integrated zero-current operation of the electric motor during such periods. Owing to this design, the electric motor is not constantly powered, which is advantageous for the service life of the electric motor, as well as for the operating costs of the motor vehicle.

### BRIEF DESCRIPTION OF THE DRAWINGS

The invention will now be described, by way of example, with reference to the accompanying drawings in which:

FIG. 1 is a schematic presentation of a clutch according to this invention, including a disengaging device and connected actuator with the clutch in an engaged state, and

FIG. 2 is a friction clutch as illustrated in FIG. 1 in disengaged state.

### DETAILED DESCRIPTION OF THE INVENTION

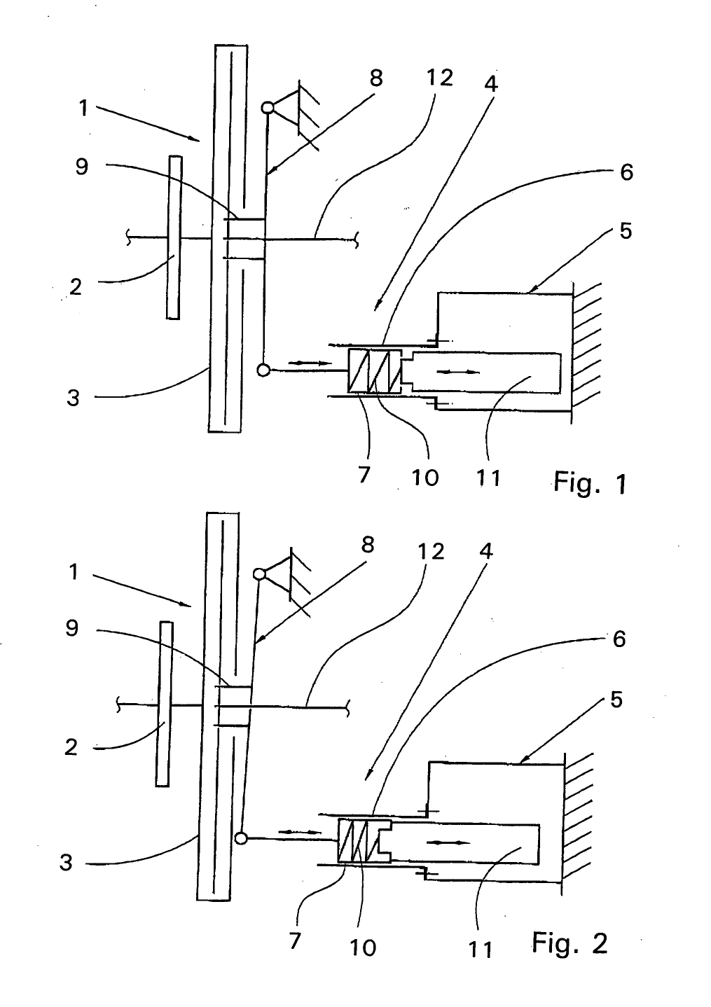

FIG. 1 shows a clutch 1 in the form of a friction clutch in an engaged position, which is situated in the power train of a motor vehicle between a combustion engine and a transmission. The basic design of such a clutch is well known so that only an explanation of the individual components of the clutch is necessary.

To begin with, the clutch 1 consists of a clutch housing 3 connected to a fly wheel 2 of the combustion engine, a torque-proof pressure plate, which is capable of axial movement within the clutch housing 3 and a diaphragm spring placed between the clutch housing and the pressure plate. The diaphragm spring comes to bear on both the clutch housing 3 and the pressure plate, the pressure plate being pretensioned in the direction of the fly wheel 2 against a clutch disk with friction lining. This side of the clutch is non-rotatably connected to a transmission input shaft 12.

A disengaging device 4 is attached to the diaphragm spring, which acts on the radial inner area of the former. The disengaging device 4 can be activated by way of an electromechanical actuator 5 and is intended to cancel the force of the diaphragm spring exerted on the pressure plate and separate the latter from the driving force of the combustion engine in the commonly known manner when the clutch is engaged. The actuator 5 preferably rests on a fixed component, such as the transmission housing (not illustrated in further detail here).

The disengaging device 4 is composed of a piston 7 fixedly connected to the electromechanical actuator 5 and routed through a flanged guide bushing 6 on the housing of the actuator. In a first possible embodiment, the piston 7 is connected via a lever system 8 to a known, separate release bearing 9 arranged coaxially to the diaphragm spring.

When the clutch is disengaged, the release bearing 9 acts on the radial inner area of the diaphragm spring as the result of an axial movement of the piston 7 toward the clutch 1, whereby the stress of the diaphragm spring on the pressure plate is canceled and, as a result, the torque transmission path from the combustion engine to the transmission input shaft 12 is interrupted (FIG. 2).

As FIG. 1 and FIG. 2 further show, a pressure spring 10 is henceforth serially integrated into the mechanical transmission path between the electromechanical actuator 5 driving the disengaging device 4 and the disengaging device 4 itself, according to the invention, in such a way that when the clutch 1 is in an engaged state (FIG. 1) a defined basic force can be generated on the disengaging device 4 or the release bearing 9, on the one hand, while a vibration isolation of the electromechanical actuator 5 is realized on the other hand.

In that way, one end of the piston 7 of the disengaging device 4 is functionally connected to the diaphragm spring, while, in the engaged state of the clutch 1, the other end is functionally connected spring-elastically via the pressure spring 10 to a displacing device 11 of the electromechanical actuator 5 acting axially on the piston.

When the clutch 1 is engaged, unavoidable vibrations from components of the disengagement mechanism, such as the lever system 8 described above, are henceforth disengaged from the actuator 5 or are absorbed by the pressure spring 10.

The electromechanical actuator 5 features an essentially known electric motor and it is, therefore, not described in further detail. The motor is connected, via a gear, to the displacing device 11, which acts axially on the pressure spring 10. In this respect, gears in the form of threaded spindle drives, which act on a displacing device 11 in the form of a displacement spindle, have proven to be advantageous. Through this measure a compact construction of the actuator 5 can be achieved which, in turn, results in reduced installation space.

FIG. 2 shows the clutch 1 in disengaged state. By way of the electric motor, an actuating force is exerted via the displacing device 11 on the pressure spring 10 and is able to overcome the spring force thereof so that, on the one hand, the displacing device 11 directly abuts the frontal end of the piston 7 while, on the other hand, the piston is displaced so far axially toward the clutch 1 that via the lever system 8. Such actuation force can be exerted on the release bearing 9 and accordingly on the diaphragm spring, which cancels the stress of the diaphragm spring on the pressure plate and thereby disengages the clutch.

For the person skilled in the art who examines the invention, it is certainly comprehensible that the basic force of the pressure spring 10 exerted on the disengaging device 4, and accordingly also on the diaphragm spring of the clutch 1 when the clutch 1 is engaged, can be realized via a definite coupling effect of the electric motor of the electromechanical actuator 5, and is continuously adjustable within defined limits.

In view of potential mechanical wear on the clutch 1 and the resulting change in displacement travel, the electromechanical actuator 5 can also be equipped with a self-calibrating displacement sensor that establishes the zero-position of the actuator 5 at any given time, and which transmits the appropriate signals to a control and regulating device for the electric motor of the actuator 5 (not illustrated in further detail). The displacement sensor can be designed for an incremental or an absolute adjustment of the zero-position of the actuator 5.

Through these measures, a nearly constant basic force on the disengaging device 4 or the release bearing 9, as the case may be, when the clutch 1 is engaged, can be ensured over the entire service life of the clutch 1 or the clutch lining thereof.

Finally, it has proven advantageous to connect the electric motor to a known brake, which therefore requires no further description, in order to maintain the generated coupling effect during the time the clutch 1 is engaged with integrated zero-current operation of the electric motor during this time, whereby the continuous powering of the electric motor can be dispensed with. As a result of this measure, increased service life of the electric motor and lower operational costs for the motor vehicle can be expected.

The illustrated embodiment involves a disengaging device that is functionally connected via a lever system 8 and a separate release bearing 9 to the diaphragm spring of the clutch 1. In contrast, it can be advantageous under defined circumstances to design the disengaging device itself as release bearing, thereby allowing the piston 7 of the disengaging device 4 to act directly on the radial inner area of the diaphragm spring in another possible embodiment.

In a clutch configured in this way, not only is a radial arrangement of the disengaging device 4 including the disengaging device 4 and actuator 5 adjacent to the transmission input shaft 12 conceivable, but a coaxial arrangement of at least the disengaging device 4 including piston 7 in relation to the transmission input shaft 12 (not illustrated in further detail) is also possible.

### REFERENCE NUMERALS

1 clutch
2 flywheel
3 clutch housing
4 disengaging device
5 electromechanical actuator
6 guide bushing
7 piston
8 lever system
9 release bearing
10 pressure spring
11 displacing device
12 transmission input shaft

1-10. (canceled)

11. A clutch (1) for situation in a power train of a motor vehicle, between a combustion engine and a transmission, the clutch comprising:
a diaphragm spring exerting stress on a pressure plate of the clutch (1) and being connected to a disengaging device (4, 9) which acts on a radial inner area of the diaphragm spring and is activated by an electromechanical actuator (5), and
a pressure spring (10) is serially integrated into a mechanical transmission path between the electromechanical actuator (5), driving the disengaging device (4, 9), and the disengaging device (4, 9) such that when the clutch (1) is in an engaged state, a defined basic force is generated on the disengaging device (4, 9) and a vibration decoupling of the electromechanical actuator (5) is realized.

12. The clutch according to claim 11, wherein the disengaging device (4) comprises a piston (7) routed though a guide bushing (6) which is fixedly connected to the electromechanical actuator (5), and the piston (7) is connected at a first end to the diaphragm spring, and a second end of the piston (7) is functionally connected to a displacing device (11) of the electromechanical actuator (5) acting axially on the piston (7), the connection is realized spring-elastically via a pressure spring (10) when the clutch (1) is in an engaged state and directly when the clutch (1) is in a disengaged state.

13. The clutch according to claim 11, wherein the electromechanical actuator (5) has an electric motor which is connected, via a gear, to a displacing device (11) acting axially on at least one of the pressure spring (10) and the piston (7).

14. The clutch as claimed in claim 13, wherein the gear is designed as a threaded spindle drive, which is drivably connected to the displacing device (11) in the form of a displacement spindle.

15. The clutch according to in claim 11, wherein the disengaging device (4) is connected, via a lever system (8), to a separate release bearing (9) acting on the radial inner area of the diaphragm spring.

16. The clutch according to claim 1 1, wherein the disengaging device (4) is a release bearing (9).

17. The clutch according to claim 11, wherein the basic force of the pressure spring (10) exerted on the disengaging device (4, 9) is realized via a defined coupling effect of the electromechanical actuator (5) that can be exerted on the spring and can be continuously adjusted within defined limits.

18. The clutch according to claim 11, wherein the electromechanical actuator (5) is provided with a self-calibrating displacement sensor that determines a zero-position of the actuator (5) each time and furnishes corresponding signals to a control and regulation device for the electric motor to allow for mechanical wear on the clutch (1) and a resulting change in a displacement travel.

19. The clutch according to claim 1 1, wherein the displacement sensor senses one of an incremental and an absolute adjustment of the zero-position of the actuator (5).

20. The clutch according to claim 11, wherein an electric motor features a brake for maintaining a generated coupling effect during a time the clutch (1) is in an engaged state with integrated zero-current operation of the electric motor during the time.
